(19) United States
(12) Patent Application Publication
(10) Pub. No.: US 2017/0017768 A1
(43) Pub. Date: Jan. 19, 2017

(54) METHOD AND SYSTEM FOR PROVIDING HEALTHCARE CONSUMABLES

(71) Applicant: Heartsquare Inc., Victoria (SC)

(72) Inventor: Ipin Hsiao, Victoria (SC)

(73) Assignee: Heartsquare Inc., Victoria (SC)

(21) Appl. No.: 15/208,672

(22) Filed: Jul. 13, 2016

(30) Foreign Application Priority Data
Jul. 15, 2015 (TW) 104122997

(51) Int. Cl. G06F 19/00

(52) U.S. Cl. CPC G06F 19/3418; G06F 19/328; G06F 19/3456

(57) ABSTRACT

A method of providing healthcare consumables is provided. The method includes the following steps: (a)providing a front-end server and a back-end server; (b)the front-end server providing at least a purchasing program for a user to choose from, wherein the purchasing program includes providing a plurality of the healthcare consumables to the user in the first instance and providing the healthcare consumables to the user free of charge within a predetermined period; (c)the front-end server recording a consumed amount of the plurality of the healthcare consumables; and (d)when the consumed amount reaches a first threshold, the front-end server submitting a requisition to replenish the healthcare consumables free of charge to the back-end server via a communication network.

### CROSS REFERENCE

This application claims the benefit of Taiwan Patent Application No. 104122997, filed on Jul. 15, 2015, at the Taiwan Intellectual Property Office, the disclosures of which are incorporated herein in their entirety by reference.

### FIELD OF THE INVENTION

The present invention is related to a purchasing system and the method thereof, particular for a purchasing system for healthcare consumables as well as the method thereof.

### BACKGROUND OF THE INVENTION

Patients who suffer from chronic diseases, such as diabetes, kidney disease and cardiovascular disease, rely daily on a physiological testing or monitoring system and consumables that the physiological testing or monitoring system requires. For example, a diabetes patient may use glucose test strips to test blood sugar at least four times a day. Thus, an ample supply of healthcare consumables is critical to diabetes patients.

In the era of the Internet, a variety of high-tech products, such as cellular phones equipped with application software, have entered our daily lives. People make use of user equipment such as cellular phones, smart wearable devices, tablet computers or even laptop computers to place purchasing orders from remote locations via the Internet. Likewise, patients under a healthcare program can also use their personal user equipment to transmit their daily physiological data collected from healthcare devices to remote medical facilities via the Internet.

Some subscription-based replenishment systems for healthcare consumables related to physiological testing or monitoring system devices are available for convenient supply of the consumables to the patients. These systems rely on patients' orders via complicated management systems and Internet communication, which are neither cost-effective nor time-effective. Ultimately, these costs are passed on to users.

Based on the above, it is desirable to provide patients with ample supply and a better cost structure. The novel design in the present invention not only solves the problems described above, but is also easily implemented. Thus, the present invention has utility for the industry.

### SUMMARY OF THE INVENTION

The main objective of the present invention is to provide a purchasing program for healthcare consumables to the users who need them. In accordance with one aspect of the present invention, a method for providing healthcare consumables is provided. The method includes the following steps: (a)providing a front-end server and a back-end server; (b)the front-end server providing at least a purchasing program for a user to choose, wherein the purchasing program includes providing a plurality of the healthcare consumables to the user in the first instance and providing the healthcare consumables to the user free of charge within a predetermined period; (c)the front-end server recording a consumed amount of the plurality of the healthcare consumables; and (d)when the consumed amount reaches a first threshold, the front-end server submitting a requisition to replenish the healthcare consumables free of charge to the back-end server via a communication network.

In accordance with one aspect of the present invention, a method for providing healthcare consumables is provided. The method includes the following steps: (a)providing a purchasing program for a user to confirm, wherein the purchasing program includes providing a plurality of the healthcare consumables to the user in the first instance and providing the healthcare consumables to the user free of charge within a predetermined period; (b)recording a consumed amount of the plurality of the healthcare consumables; and (c)submitting a requisition to replenish the healthcare consumables free of charge when the consumed amount reaches a first threshold.

In accordance with a further aspect of the present invention, a system for providing a purchasing program to obtain healthcare consumables is provided. The system comprises a measurement device, and a communication module. The measurement device is configured to work with the healthcare consumables, and record a consumed amount of the healthcare consumables. The communication module submits a requisition to replenish the healthcare consumables free of charge when the consumed amount reaches a first threshold, based on the purchasing program.

In accordance with a further aspect of the present invention, a method for initiating reminders to replenish free healthcare consumables on a front-end server to a computer for implementation is provided. The method includes steps of: (a)providing at least a purchasing program for a user to choose; (b)detecting a consumption amount of the healthcare consumables; and (c)submitting a reminder for free replenishment of the healthcare consumables when the consumption amount of the healthcare consumables reaches a threshold.

In accordance with a further aspect of the present invention, a method for providing healthcare consumables is provided. The method includes steps of: (a)providing a measurement device working together with one of the healthcare consumables; (b)providing a management unit containing a purchasing program for obtaining the healthcare consumables; (c)a user confirming the purchasing program; and (d)the management unit detecting a consumption amount of the healthcare consumables from the measurement device, wherein the management unit submits a reminder for replenishment of the healthcare consumables to the user when the consumption amount of the healthcare consumables reaches a first threshold, and terminates the measurement unit when the consumption amount of the healthcare consumables reaches a second threshold.

In accordance with a further aspect of the present invention, a method for controlling a measuring function of a measurement device is provided, the method including: providing the measurement device; accumulating a used amount of the measuring function of the measurement device; and when the used amount reached a threshold, terminates the measuring function of the measurement device.

In accordance with a further aspect of the present invention, a method for controlling a measuring function of a measurement device is provided, the method including: providing the measurement device with a resettable allowable amount of measurement; subtracting the resettable allowable amount of measurement by one for each time the measurement device performs the measuring function; and terminating the measuring function of the measurement device when the resettable allowable amount of measurement becomes zero.

In accordance with a further aspect of the present invention, a method for providing purchasing programs for healthcare consumables is provided. The method includes steps of: (a)providing a measurement device and a management unit containing a plurality of purchasing programs for obtaining the healthcare consumables; (b) a user choosing one of the plurality of purchasing programs; and (c)based on the user's choice, the measurement device setting itself to be only capable of reading a type of healthcare consumables according to one of the plurality of purchasing programs or corresponding to the measurement device.

In accordance with a further aspect of the present invention, a method for providing purchasing programs for healthcare consumables is provided. The method includes providing a management unit, wherein the management unit set a measurement device to be capable of reading a plurality of healthcare consumables, each of which corresponding to the measurement device and at least a purchasing program.

In accordance with a further aspect of the present invention, a method for providing purchasing programs for healthcare consumables is provided. The method includes steps of: (a)providing a plurality of purchasing programs for obtaining the healthcare consumables to a user to choose, wherein each of the purchasing programs includes at least one of effective period, payment amount and whether to obtain a measurement device free of charge; (b)based on a user's chosen purchasing program, determining a pre-determined amount of a plurality of the healthcare consumables to be supplied to the user in the first instance; (c)recording a consumed amount of the healthcare consumables; and (d) submitting a requisition to replenish the healthcare consumables free of charge when the consumed amount reaches a threshold.

In accordance with a further aspect of the present invention, a method for providing purchasing programs for healthcare consumables is provided. The method includes steps of: (a)providing a plurality of purchasing programs for obtaining the healthcare consumables to a user to choose, wherein each of the purchasing programs includes at least one of effective period, payment amount and whether to obtain a measurement device free of charge; (b)providing a plurality types of the healthcare consumables to be supplied to the user with respect to the plurality of purchasing programs; and (c)providing at least one type of the healthcare consumables to the user based on the user's chosen purchasing program.

In accordance with a further aspect of the present invention, a method of providing purchasing programs for measurement consumables is provided. The method includes steps of: (a)providing a measurement device and a management unit; (b)the management unit providing a purchasing program for a user to determine; and (c)based on the user's choice, the management unit setting the measurement device to be only capable of reading a type of healthcare consumables according to the plurality of purchasing programs or corresponding to the measurement device, wherein the measurement device corresponds to the user, and the measurement consumables correspond to the measure device.

In accordance with a further aspect of the present invention, a system for providing purchasing programs for measurement consumables is provided. The system includes a management unit, a measurement unit and the measurement consumable, wherein the management unit provides a purchasing program for a user to determine, the measurement device corresponds to user's chosen purchasing program, and the measurement consumables correspond to the measure device.

In accordance with a further aspect of the present invention, a method for providing purchasing programs for healthcare consumables is provided. The method includes steps of: (a)providing a plurality of purchasing programs for obtaining the healthcare consumables to a plurality of users to choose, wherein each of the purchasing programs includes at least one of effective period, payment amount and whether to obtain a measurement device free of charge; (b)based on each of the users' chosen purchasing program, determining a pre-determined amount of a plurality of the healthcare consumables to be supplied to the users in the first instance, wherein the healthcare consumables for each of the users has a different identification medium; (c)recording a consumed amount of the healthcare consumables; and (d) submitting a requisition to replenish the healthcare consumables free of charge when the consumed amount reaches a threshold.

In accordance with a further aspect of the present invention, a method for providing purchasing programs for healthcare consumables is provided. The method includes steps of: (a)providing a plurality of purchasing programs for obtaining the healthcare consumables to a plurality of users to choose, wherein each of the purchasing programs includes at least one of effective period, payment amount and whether to obtain a measurement device free of charge; and (b)based on each of the users' chosen purchasing program, determining a pre-determined amount of a plurality of the healthcare consumables to be supplied to the user in the first instance, wherein the healthcare consumables for each of the users has an identical identification medium.

In accordance with a further aspect of the present invention, a method of monitoring a consumed amount of healthcare consumables is provided. The method includes steps of: (a)providing a measurement device and a management unit; (b)providing a plurality of purchasing programs for obtaining the healthcare consumables for a user to choose; (c)based on the user's choice, setting the measurement device to be only capable of reading a corresponding type of healthcare consumables, and (d)the management unit sending a notice to a management center when the measurement unit is configured to read a healthcare consumable which is of a type different from the corresponding type of healthcare consumables.

In accordance with a further aspect of the present invention, a method for monitoring a consumed amount of healthcare consumables is provided. The method includes steps of: (a)providing a measurement device and a management unit; (b)providing a plurality of purchasing programs for obtaining the healthcare consumables for a user to choose; (c)based on the user's choice, setting the measurement device to be only capable of reading a corresponding type of healthcare consumables, and (d) when the measurement unit is tended to be configured to read a healthcare consumable which is of a type different from the corresponding type of healthcare consumables, the management unit sending an error message to a user who uses the measurement unit.

The above objectives and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic diagram of the system for providing purchasing programs for healthcare consumables according to one embodiment of the present invention;

FIG. 1B is a schematic diagram illustrating an example of the process of a user equipment registering onto a transaction platform via application software according to one embodiment of the present invention;

FIG. 1C shows a schematic diagram illustrating an example when a first-time user starts to purchase the flat-rate service via a user equipment according to one embodiment of the present invention;

FIG. 1D is an exemplary embodiment of daily blood glucose monitoring according to one embodiment of the present invention;

FIG. 2 is a schematic diagram of a system for providing a purchasing program for healthcare consumables according to one embodiment of the present invention;

FIG. 3 shows a process flow according to another embodiment of the present invention;

FIG. 4 is a schematic diagram showing a system for providing two purchasing programs for healthcare consumables according to yet another embodiment of the present invention;

FIG. 5 shows a process flow according to the embodiment of FIG. 4.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; they are not intended to be exhaustive or to be limited to the precise form disclosed.

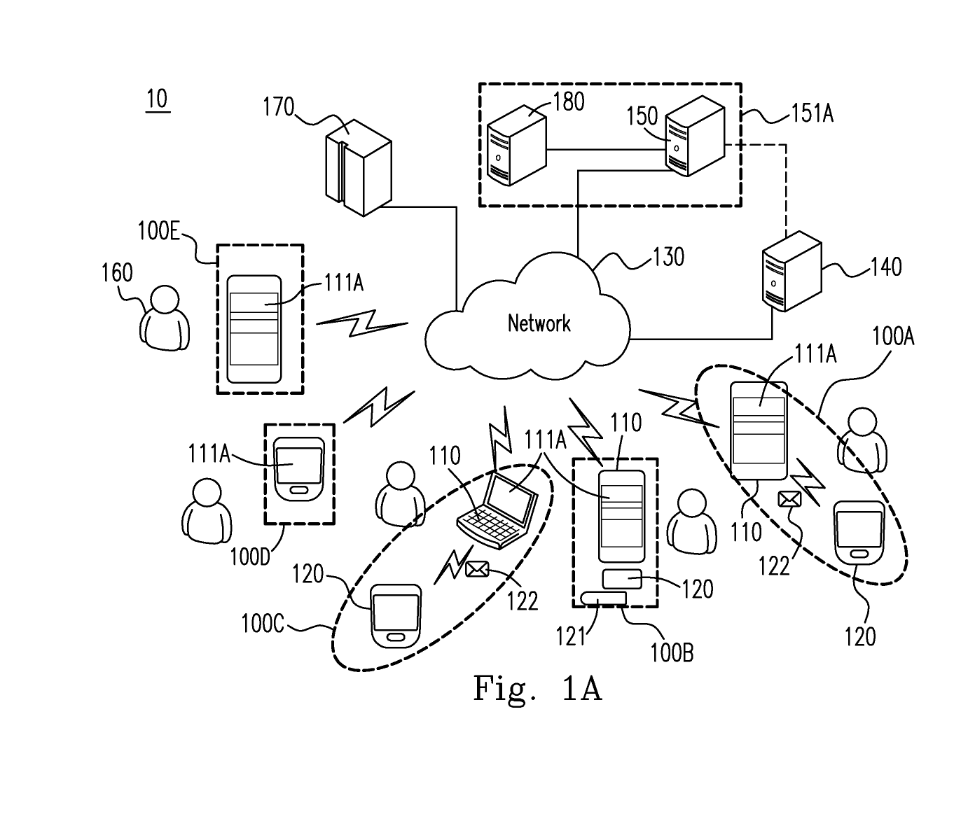

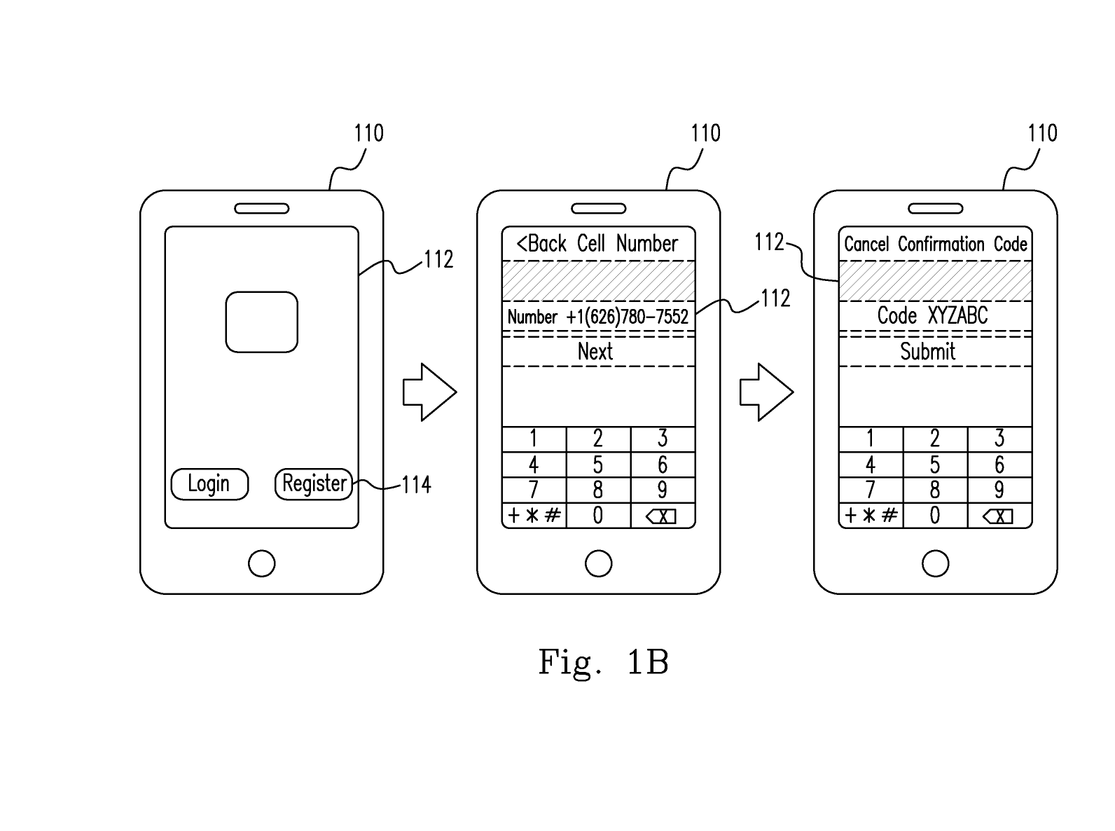

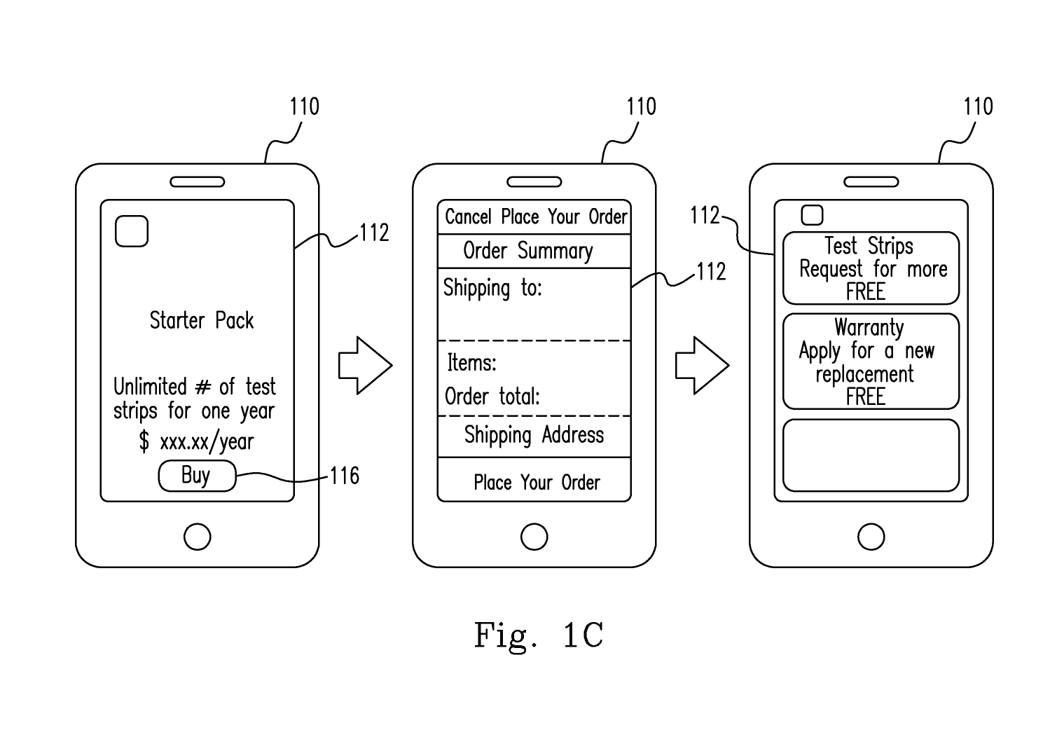

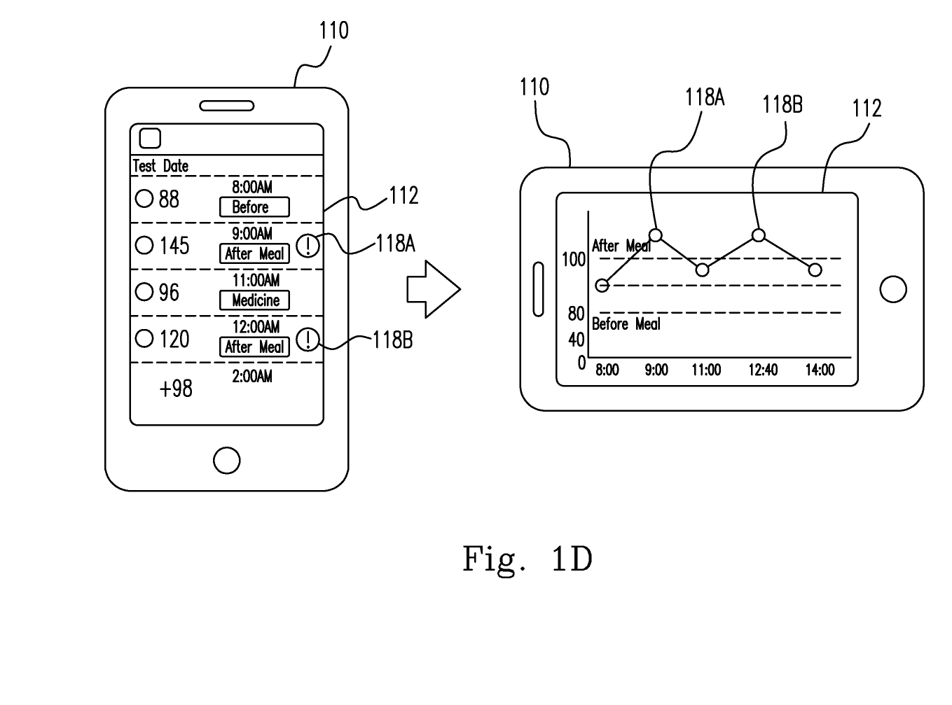

To benefit patients who need large supplies of healthcare consumables on a regular basis, the present invention provides a system for providing purchasing programs for healthcare consumables. Referring to FIG. 1A, the system 10 comprises a measurement device 120 configured to work with a healthcare consumable 121 having a consumed amount and a management element configured to monitor the consumed amount. When the consumed amount reaches a threshold, the management unit will submit a requisition to replenish the healthcare consumables free of charge based on the purchasing program.

In one embodiment of the present invention, a method for providing inspection consumables is disclosed. The method includes steps of: the supplier to provide at least a purchasing program (such as a flat-rate per month) for a user to choose. The user can be a diabetes patient who needs to consume many blood glucose test strips used in a blood glucose tester for long-term monitoring. With the benefit of the present invention, patients can obtain a large supply of healthcare consumables to fulfill their daily needs at low cost while avoiding manual transactions in connection with purchasing the inspection consumables. The purchasing program includes but is not limited to: the vendor provides a plurality of the related consumables, such as 300 blood glucose test strips, to the user in the first instance.

In retailing programs, which are the purchasing methods of paying for a particular amount of the related consumables by a user based on personal needs, patents with mild diabetes symptom can purchase inspection consumables at a reasonable and convenient manner. Thus, limited medical resources can be optimized and distributed under one system if a front-end server of the management unit can provide at least two types of purchasing programs to the users and the appropriate purchasing program can be chosen based on the different needs of the patents such as mild or heavy users, and each purchasing program corresponds to a specific consumable type.

The aforementioned related consumables are test strips for analyzing materials. One embodiment of the present invention is to have the same or different type of test strips designed with regard to different purchasing programs. On the other hand, in other embodiments, the inspection or healthcare consumables can be different analytical test strips such as blood glucose, uric acid, cholesterol, blood ketone, pesticide, heavy metal or carcinogen.

Please refer to FIG. 1A, which is a schematic diagram of the system 10 for providing purchasing programs for healthcare consumables according to one embodiment of the present invention. The following descriptions are based on blood glucose test strips as only one example. It can be appreciated that other types of test strips for detecting other materials such as uric acid, cholesterol, blood ketone, pesticide, heavy metal or carcinogen are also applicable according to the present invention. Thus, other than physiological indices, test trips for environmental contamination are applicable in these embodiments.

In FIG. 1A, the system 10 includes a physiological measurement device 100A, 100B, 100C and a management unit. The management unit includes a front-end server 111A providing user interfaces for users to purchase orders and a back-end server 151A performing purchase order implementation. The back-end server 151A can be a computer, a computer system or a server, while the front-end server 111A can includes application programs loaded in an electronic device, a software or cloud software.

In the first embodiment, the physiological measurement device 100A, 100B, 100C consists of a user equipment 110 and a physiological measurement device 120, each of which is an independent device. The two devices can be connected to each other in a wired or wireless manner. The functions of the front-end server 111A in the management unit can be implemented by the user equipment 110. For example, the user equipment 110 in the physiological measurement device 100A is a smart phone while the physiological measurement device 120 is an independent blood glucose meter, and the two devices are connected via wireless communication such as Bluetooth. The user equipment 110 in the physiological measurement device 100B is a smart phone while the physiological measurement device 120 is a blood glucose meter without a display, and the two devices are connected via wired communication such as USB ports. The user equipment 110 in the physiological measurement device 100C is a laptop computer while the physiological measurement device 120 is an independent blood glucose meter, and the two devices are connected via wireless communication using protocols such as Bluetooth. The mentioned user equipment 110 can be, but not limited to, electronic devices such as a smart phones, a tablet computer, a laptop computer, a desktop computer, a PDA or wearable devices. The physiological measurement device 120 can be, but not limited to, an independent blood glucose meter or a blood glucose meter without a display device. The connecting method between the user equipment 110 and the physiological measurement device 120 can be, but is not limited to, wireless communications such as WIFI, Bluetooth, infrared, near field communication (NFC), radio frequency identification (RFID), Zigbee or cellular internet connections, or wired communications such as universal serial bus (USB) ports, audio ports, or Ethernet connections.

In the second embodiment, the physiological measurement device 100D is an intelligent physiological measurement device capable of implementing the functions of the front-end server 111A and transmitting information via either wired or wireless communications. The physiological measurement device 100D can be: intelligent blood glucose meter with a communication module which can communicate with others via cellular wireless communication networks or the aforementioned wireless networks.

In the third embodiment, the physiological measurement device 100E can be an electronic device with physiological measurement functions and capable of implementing the functions of the front-end server 111A, such as: a smart phone, a personal data assistant (PDA) or a wearable device with an embedded blood glucose measurement module.

The detailed implementation of the first embodiment using the physiological measurement device 100A-100C is set forth below. The user equipment 110 includes the front-end server 111A in the management unit. The front-end server 111A can be connected to the back-end server 151A via a communication network 130, and the back-end server 151A is either directly (as shown with dotted line) or via the communication network 130 connected to a transaction platform 140 where a user 160 can pay the bill thereon. Transaction platform 140 can be, but is not limited to, third-party payment, credit card payment or wed ATM. The communication between the user equipment 110 and the communication network 130 can be in a wired or wireless manners such as the Internet, a wireless local access network (WLAN), a cellular wireless communication network, an Ad-hoc network or a combination thereof.

The user 160 can identify his/her identity by the front-end server 111A of the user equipment 110 through the communication network 130. When the user 160 chooses to buy a purchasing program providing the related healthcare consumables, the purchasing program can be a flat-rate program, which provides the user with a plurality of related consumables free of charge during a predetermined period after the user has paid the bill for the program. The predetermined period can be determined by the supplier or counted by day, by month, by season or per year.

If the user 160 chooses a flat-rate purchasing program for obtaining blood glucose test strips along with a blood glucose meter, he/she may connect to the transaction platform 140 to pay the bill. The purchasing information will then be transmitted to the management end 150 and the dispatching end 180 of the back-end server 151A to complete the dispatching process.

The physiological measurement device 120 transmits the strip record 122 to the user equipment 110 via the wired or wireless connection when the user 160 has received the purchased blood glucose test strips and the connection between the physiological measurement device 120 and the user equipment 110 exists.

In addition, according to another embodiment of the present invention, all the relevant information and records for the user 160 at the physiological measurement device 120 can be transmitted to the management end 150 of the back-end server 151A via the communication network 130 to track and monitor the consumed amount of the test strips, or transmitted to a healthcare center 170 for management, under the user's agreement.

When medical professionals or healthcare providers find an abnormal incident in the test trip records, they can inform the user 160 through a phone-call or short messages to provide timely medical consultation or notification and register the user 160 for a clinic visit with a doctor per the healthcare provider's suggestion or the user's approval.

Compared to the first embodiment, the differences in the other embodiments are: In the physiological measurement device 100D of the second embodiment, the user equipment 110 and the physiological measurement device 120 are replaced with an intelligent blood glucose meter, which can implement the functions of the front-end server 111A and includes a communication module, the user can obtain services from the system using the front-end server 111A connected to the back-end server 151A via either the mentioned wireless network or a wired network connection; and in the physiological measurement device 100E of the third embodiment, the user equipment 110 and the physiological measurement device 120 are replaced with an electronic device embedded with physiological measurement functions, which can implement the functions of the front-end server 111A and includes a communication module. The user can perform identification or purchase using the front-end server 111A connected to the back-end server 151A.

In the system according to present invention, measurement records or data collected from the test strips can be defined to be correction prevented to avoid any data corrected by either the user or doctors. The data can be provided to insurance providers as evidence that the compensation has been paid.

It can be appreciated by the skilled person in the art that, by means of the Internet communication system, the present invention can provide patients suffering from diabetes with homecare services at a reasonable cost. The front-end server 111A in the management unit can be obtained by downloading from the Internet or a remote connection or other means according to techniques in the art.

Please refer to FIG. 1B, which shows a schematic diagram illustrating an example of the process where the user equipment 110 of a user registers onto the back-end server 151A via the front-end server 111A with the user's identity, which can be a confirmation code in connection with the user's cellular phone number. The left of FIG. 1B shows an exemplary initial screen of the front-end server 111A when a user 160 logs in or registers on the back-end server 151A. After the user 160 clicks the register icon 114 on the screen 112, the screen 112 shows layouts for the user 160 to input his or her cellular phone number and the confirmation code directing to the user equipment 110 for verification process. The confirmation code was sent to the user equipment 110 of the user via internet from the back-end server 151A in a request of front-end server 111A. Once the user 160 has established an account, at least one of the user's identities such as personal identification number, name, password and phone number, are associated with the user 160 to help the back-end server 151A identify the user 160.

In another embodiment, one may use the unique identification number or icon (such as a confirmation code and a serial number or bar code) of the physiological measurement device to perform a verification process verifying the identity of the physiological measurement device with the back-end server 151A.

Compared to the first embodiment, the differences in the other embodiments are: In the physiological measurement device 100D of the second embodiment, the user equipment 110 is replaced with an intelligent blood glucose meter, which can implement the functions of the front-end server 111A and includes a communication module, the user can go through the verification process using the front-end server 111A connected to the back-end server 151A; and in the physiological measurement device 100E of the third embodiment, the user equipment 110 and the physiological measurement device 120 are replaced with an electronic device embedded with physiological measurement functions, which can implement the functions of the front-end server 111A. The user can perform verification or purchase using the front-end server 111A connected to the back-end server 151A.

Please refer to FIG. 1C, which shows a schematic diagram illustrating an example of when a first-instance user starts to purchase the flat-rate service via the user equipment 110 in the physiological measurement device 100A-100C of the first embodiment, the intelligent blood glucose meter in the physiological measurement device 100D of the second embodiment, or the user equipment 110 embedded with physiological measurement functions in the physiological measurement device 100E of the third embodiment. The left of FIG. 1C shows an exemplary screen of the application software 111A when a user 160 tends to buy a starter pack of the flat-rate access from the back-end server 151A (not shown). After clicking the buy icon 116 on the screen 112, the application software 111A shifts to a order-placing screen as illustrated in the middle of FIG. 1C.

In one embodiment of the present invention, the user 160 may choose to request more healthcare consumables for free if necessary. When the physiological measurement device 120 is damaged but still under the warranty period, the user 160 may request a replacement for free via the application software 111A.

Please refer to FIG. 1D, which shows an exemplary embodiment of daily blood glucose monitoring with the front-end server 111A loaded in the user equipment 110 in the physiological measurement device 100A-100C of the first embodiment, the intelligent blood glucose meter in the physiological measurement device 100D of the second embodiment, or the user equipment 110 embedded with physiological measurement functions in the physiological measurement device 100E of the third embodiment.

The measurement records, including the test data, the test time and other relevant information, can be shown on the screen 112. Furthermore, according to the illustrations on the left of FIG. 1D, two outliners 118A and 118B are identified. A chart can be generated by the application software 111A, as shown in the right of FIG. 1D, where the measurement records are illustrated against control limits shown with dotted lines. It can be appreciated that the two outliners 118A and 118B are above the after-meal control limit. All these measure records will be transmitted to the back-end server 151A in the management end 150 for record keeping and further analysis. The management end 150 may also predict a user's current consumption of healthcare consumables based on the measurement records, and informs the user equipment 110 when the user's current consumption exceeds a threshold, indicating that the user 160 may need to reorder more healthcare consumables. When such a message is delivered to the user 160 via the front-end server 111A, the user equipment 110 may initiate a resupply shipment request subject to the user's approval without manual intervention, enabling the user 160 to maintain a comfortable stock of the healthcare consumables. Notably, replenishment orders are free of charge, apart from the flat-rate.

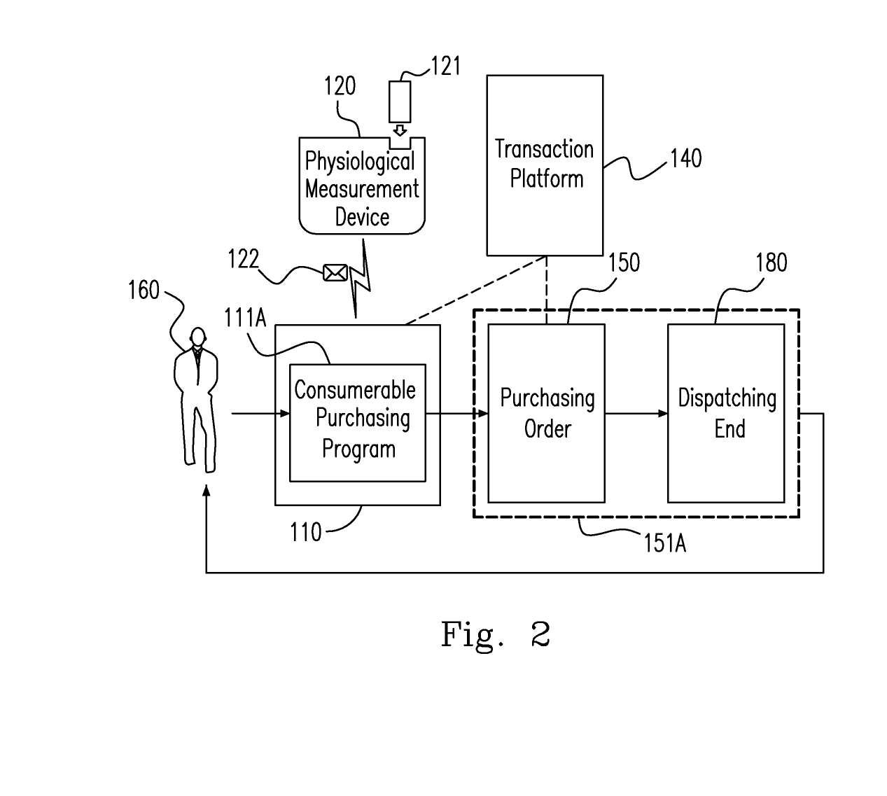

Please refer to FIG. 2, which is a schematic diagram of a system for providing a purchasing program for healthcare consumables according to the first embodiment of the present invention. When a user 160 logs in to a front-end server 111A on the management unit and selects a purchasing program providing blood glucose test strips related to the physiologic measurement device, the front-end server 111A transmits the information for the chosen purchasing program to a management end 150 of a back-end server 151A for processing purchasing orders, and a dispatching end 180 of the back-end server 151A forwards an initial amount of the test strips to the user 160. To save time and management cost, a transaction platform can be used to receive the payment for the purchasing program. The payment can be transacted by credit card, web ATM, or a third-party payment.

For patents consuming large amounts of glucose test strips, using flat-rate purchasing programs can reduce the cost of obtaining the glucose test strips, and the flat-rate payment can help to save transaction costs and enjoy home delivery services, which largely increases convenience. As for the test strip vendors, the present invention helps to reduce the cost of entity channels and provide cost-effective services to the patients. When the physiological measurement device 120 is connected to the user equipment 110, the front-end server 111A can estimate the user's health status based on the strip records 122, which includes the tested data in terms of glucose, the consumed amount of the strip, type of the strip, time and date of the measurement performed, meal status, health records, etc. In essence, the user's health status can be estimated by analyzing the strip records 122 using statistical tools such as control charts or trend charts. The consumed amount can be, but is not limited to, the accumulated times of measurement performed by the physiological measurement device 120, the used amount of the test strips, or the number of test records transmitted to the front-end server 111A. Subject to the user's approval, the user equipment 110 can inform a health care provider such as a medical center 170 of the user's health status, and register the user 160 for a clinical visit when suggested by the health care provider. The measurement records can be provided to the medical center 170 for preliminary review by a doctor or other health care provider, so that the health care provider can determine whether a clinical visit is advisable. With the aid of Internet communication systems, a skilled person in the art can appreciate that home care services for diabetes patients can be delivered at reasonable cost.

The user 160 can use the front-end server 111A to start daily monitoring of his/her own blood glucose record. The management end 150 at the back-end server 151A can receive the information including test strip records 122, the user's identity or notation, messages regarding the chosen purchasing program, etc., collected by the front-end server 111A via a communication network 130. The consumed amount of the test strips can be obtained based on data collection from at least one of the physiological measurement device 120 with a counting function, the user equipment 110 and the back-end server 151A. The test strip records 122 can be irrevocable or unchangeable to avoid potential fraud or cheating which can be provided to insurance providers as evidence that the compensation was paid.

Compared to the first embodiment, the differences in the other embodiments are: In the physiological measurement device 100D of the second embodiment, the user equipment 110 and the physiological measurement device 120 are replaced with an intelligent blood glucose meter, which can implement the functions of the front-end server 111A and includes a communication module. The user can select purchasing program(s) via the front-end server 111A in the blood glucose meter. The strip's test data 122 obtained after measurement can be directly stored in the memory of the blood glucose meter. Through the front-end server 111A, the measured blood glucose data can be transmitted to the back-end server 151A for subsequent analysis and management.

In the physiological measurement device 100E of the third embodiment, the user equipment 110 and the physiological measurement device 120 are replaced with an electronic device embedded with physiological measurement functions, which can implement the functions of the front-end server 111A and includes a communication module. The user can select purchasing program(s) via the front-end server 111A in the electronic equipment. The strip's test data 122 obtained after measurement can be directly stored in the electronic equipment. The user can also monitor his/her own blood glucose data by using the front-end server 111A. The measured blood glucose data can be transmitted to the back-end server 151A for subsequent analysis and management.

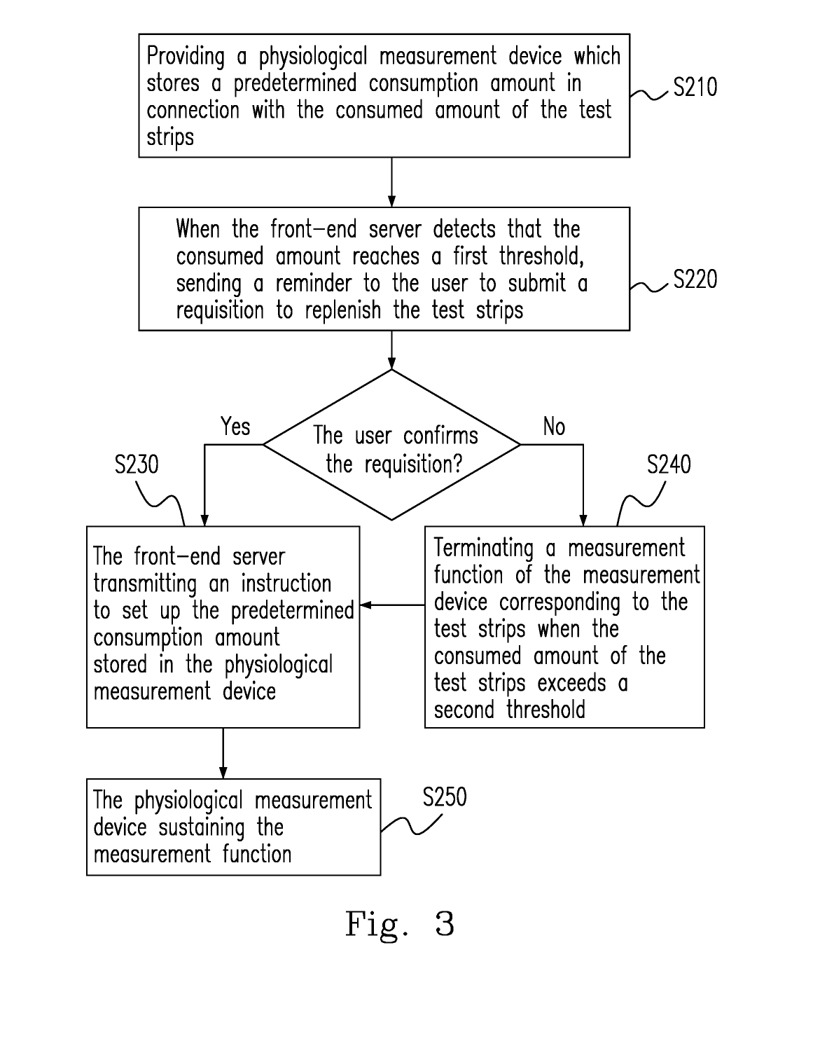

Please refer to FIG. 3, which shows a process flow according to exemplary embodiments of the present invention. In the first embodiment using the physiological measurement device 100A-100C, the physiological measurement device with a recording unit configured to store the consumed amount of the test strips and a predetermined consumption amount in connection with the consumed amount of test strips is provided (Step S210). The front-end server 111A sets a threshold for replenishment. When the front-end server 111A detects that the consumed amount reaches the threshold for replenishment, under an effective period of the purchasing program that the supplier has to provide the user with healthcare or inspection consumables at a flat-rate with the effective period, the front-end server 111A sends a reminder to the user to submit a requisition to replenish the healthcare or inspection consumables such as test strips (Step 220). If the user confirms the requisition, the front-end server 111A transmits an instruction to reset the predetermined consumption amount stored in the physiological measurement device (Step S230) to maintain the measurement function of the physiological measurement device 120 (Step S250). When the effective period of the purchasing program is over, the front-end server 111A will provide at least a purchasing program for the healthcare or inspection consumables to the user 160 to choose from. The back-end server 151A will dispatch an initial amount of the healthcare or inspection consumables (test strips) to the user 160 when the back-end server 151A receives the information regarding the purchasing program chosen by the user 160 through the communication network 130.

According to some embodiments, the user 160 already owns the physiological measurement device 120 capable of using the test strips. In other embodiments, the back-end server 151A will dispatch a physiological measurement device 120 to the user 160 if the purchasing program selected by the user 160 includes providing a physiological measurement device free of charge.

The embodiments as illustrated in FIG. 3 can also include using a user identification program to verify the identity of the user 160 and register the user's identity via front-end server 111A (Referring to FIG. 1B).

The consumed amount of test strips changes as the test strips are used. When the consumed amount exceeds a predetermined threshold, the physiological measurement device 120 will terminate the measurement function corresponding to the test strips (Step S240). For example, when the consumed amount exceeds 300, the measurement function will be terminated. Another embodiment sets a control number as 300 and subtracts the consumed amount each time from the control number. When the control number reaches zero, the measurement function will be terminated. Following this example, one may set the threshold for replenishing the test strips at 200, and the front-end server 111A will send the reminder requesting for replenishment to the user 160 for approval or confirmation. After the user 160 has confirmed the request for replenishment, the front-end server 111A resets the control number as 300 to sustain the measurement function of the physiological measurement device 120. The fact that control number is larger than or equal to the replenishment number of strips can provide the user 160 with an amount of strips as a buffer for test failures or experimental tests.

In addition, there can be more than one threshold for reminding the user 160 to request replenishment of the test strips, and so the user 160 can be reminded more than once. The threshold for reminding the user 160 to request replenishment of the test strips can be dynamic, which is adjusted based on the user's test records. Tracking the consumed amount of the test strips can help to remind the user 160 to keep an appropriate stock of test strips at hand.

Under the aforementioned operation models, the measurement function of the physiological measurement device 120 will be terminated when the purchasing program or contact is over, or any abnormal use of the test strips occurs, to insure the appropriate use of the physiological measurement device 120.

In addition, if the physiological measurement device is not often connected to the user equipment, the front-end server 111A can automatically send the reminder to request replenishment to the user 160 in a predetermined period, which can be determined based on experimental data according to the consumption records of the majority of other users.

Compared to the first embodiment, the differences in the other embodiments are: In the physiological measurement device 100D of the second embodiment, the user equipment 110 and the physiological measurement device 120 are replaced with an intelligent blood glucose meter, which can implement the functions of the front-end server 111A and includes a communication module, the user can obtain services from the system using the front-end server 111A connected to the back-end server 151A via either the mentioned wireless network or a wired network connection; and in the physiological measurement device 100E of the third embodiment, the user equipment 110 and the physiological measurement device 120 are replaced with an electronic device embedded with physiological measurement functions, which can implement the functions of the front-end server 111A and includes a communication module. When the consumed amount of the strips reaches or exceeds a predetermined threshold, the measurement function of the physiological measurement device 120 will be terminated.

In another embodiment of the present invention, the consumed amount of test strips can be monitored by one of the back-end server 151A, the user equipment 110, intelligent glucose meter or any electronic device with embedded physiological measurement functions. If an abnormal consumption event is found, the user will be reminded of testing blood glucose more often. The system can also terminate the contract with the user based on the data following the abnormal usage.

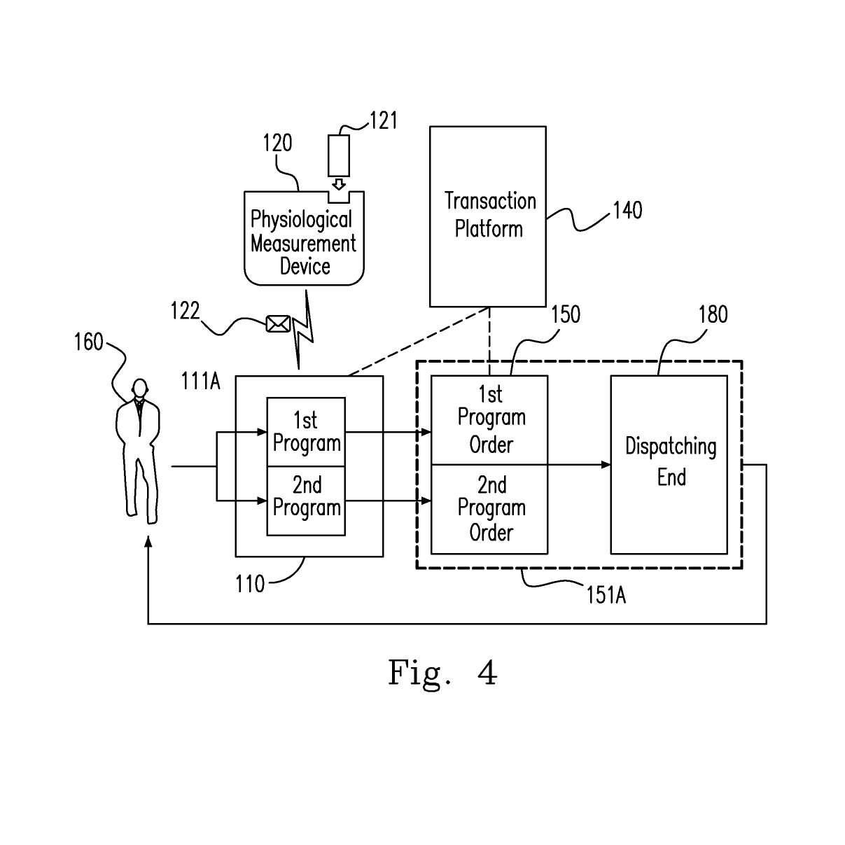

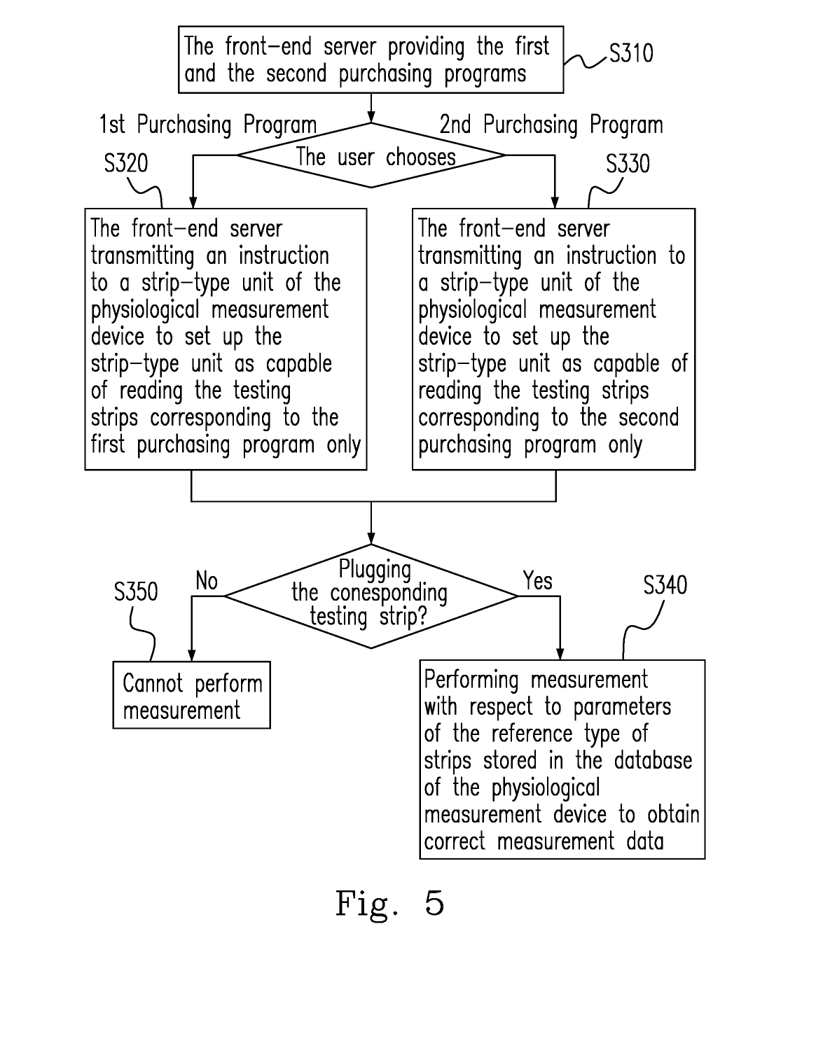

Please refer to FIGS. 4 and 5. The following descriptions are based on the first embodiment using the physiological measurement device 100A-100C as an exemplary embodiment. In step 310, the front-end server 111A provides the first and the second purchasing programs for a user 160 to choose from. If the user 160 chooses the first purchasing program, the front-end server 111A will transmit an instruction to a strip-type unit of the physiological measurement device 120 to set up the strip-type unit as capable of reading the testing strips corresponding only to the first purchasing program when the electrical device 110 is connected to the physiological measurement device 120 (S320). If the user 160 chooses the second purchasing program, the front-end server 111A will transmit an instruction to a strip-type unit of the physiological measurement device 120 to set up the strip-type unit as capable of reading the testing strips corresponding only to the second purchasing program when the electrical device 110 is connected to the physiological measurement device 120 (S330). In other words, when a test strip is inserted into the measurement device, any test trip other than the type as set up by the strip-type unit of the physiological measurement device 120 cannot trigger the measurement function of the physiological measurement device 120. When a readable test trip is inserted into the physiological measurement device 120, the stored parameters such as calibration parameters corresponding to the type of the inserted test strip will be used to calculate and obtain measurement data. The user 160 may choose to change to another purchasing program when the contact is due for renewal. The test strips according to the purchasing program will be replenished when the stock at the user's location is about to be used up. The front-end server 111A receives the purchasing information chosen by the user 160, and sends the purchasing information to the management end 150 of the back-end server 151A to process the information. The back-end server 151A also assesses whether a request for replenishing the test strips is reasonable, and forwards the relevant information to the dispatching end 180 to dispatch the test strips to the user 160. The user 160 can pay for the purchase contract at the transaction platform 140, which can be a third-party payment service provider, network ATM or other service provider. In one embodiment, the threshold for replenishment of the test strips can be a percentage or ratio of the purchased amount in the first instance. For example, when the consumed amount reaches 70% of the purchased amount in the first instance, the user can either request a replenishment or choose to switch to another purchasing program. The physiological measurement device can be configured to distinguish between different types of test strips using an identification element with mechanical or electrical codes. The physiological measurement device 120 has a database that stores a first parameter corresponding to the first type of test strips and a second parameter corresponding to the second type of test strips. The physiological measurement device 120 performs measurements with regard to the parameters of the reference type of strips stored in the database of the physiological measurement device 120 to obtain measurement data (Step S340).

Compared to the first embodiment, the differences in the other embodiments are: In the physiological measurement device 100D of the second embodiment, the user equipment 110 and the physiological measurement device 120 are replaced with an intelligent blood glucose meter, which can implement the functions of the front-end server 111A and includes a communication module, the user can obtain services from the system using the front-end server 111A connected to the back-end server 151A via either the mentioned wireless network or a wired network connection; and in the physiological measurement device 100E of the third embodiment, the user equipment 110 and the physiological measurement device 120 are replaced with an electronic device embedded with physiological measurement functions, which can implement the functions of the front-end server 111A.

In the following a first embodiment using the physiological measurement device 100A-100C as example, test strips of the first and the second types of test strips can be distinguished because of the encoding element thereon. For example, the test strips can be coded with mechanical coding such as punched holes, saw teeth, through holes and notches or electronic coding such as conducting elements and insulated elements so as to allow the physiological measurement device 120 to verify the type of the test strips by decoding the code thereon. In other embodiments, the type of the test strips can be verified by using RFID technology, barcodes, color or the combination thereof. The aforementioned test strips are for the same kind of physiological test, and the aforementioned database can also be configured and updated in the front-end server 111A. For example, the front-end server 111A is configured to provide the user 160 with the first and the second purchasing programs. If the user 160 chooses the first purchasing program, the front-end server 111A will transmit an instruction to a strip-type unit of the physiological measurement device 120 to set up the strip-type unit as capable of reading the testing strips corresponding only to the first purchasing program when the electrical device 110 is connected to the physiological measurement device 120. If a test strip of the type different from the type corresponding to the first purchasing program is plugged into the physiological measurement device 120, the physiological measurement device 120 cannot perform the measurement (Step S350).

Compared to the first embodiment, the differences in the other embodiments are: In the physiological measurement device 100D of the second embodiment, the user equipment 110 and the physiological measurement device 120 are replaced with an intelligent blood glucose meter, which can implement the functions of the front-end server 111A and includes a communication module, the user can obtain services from the system using the front-end server 111A connected to the back-end server 151A via either the mentioned wireless network or a wired network connection; and in the physiological measurement device 100E of the third embodiment, the user equipment 110 and the physiological measurement device 120 are replaced with an electronic device embedded with physiological measurement functions, which can implement the function of the front-end server 111A.

Further, according to the method, the initial amount of the healthcare consumables to be supplied to the user 160 is determined and modified based on a statistical method, using for example, the mean value of the consumables used over a predetermined period such as one to three months for most users, and is not necessarily constant. The flat-rate service/access is cost-effective for patients who use high volumes of healthcare consumables. By reducing transaction cost, the flat-rate service/access is also cost-effective for the healthcare consumable providers.

In one embodiment of the present invention, the measurement steps illustrated on the physiological measurement device 120 will be also shown on the user equipment 110 when the two devices are connected via a network or communication ports, so the user can clearly understand the current process when he/she is using the user equipment 110. In addition, all of the test data can be simultaneously transmitted to the front-end server 111A.

In some other embodiments according to the present invention, the physiological measurement device 120 is configured to measure blood glucose, uric acid, cholesterol, blood ketone, pesticide, heavy metal, carcinogen or an environmental contaminant.

While the invention has been described in terms of what are presently considered to be the most practical and preferred embodiments, it should be understood that the invention need not be limited to the disclosed embodiments. On the contrary, it is intended to cover various modifications and similar arrangements included within the spirit and scope of the appended claims, which are to be accorded the broadest interpretation possible, so as to encompass all such modifications and similar structures.

### EMBODIMENTS

1. A method of providing healthcare consumables, comprising: (a)providing a front-end server and a back-end server; (b) the front-end server providing at least a purchasing program for a user to choose from, wherein the purchasing program includes providing a plurality of the healthcare consumables to the user in the first instance and providing the healthcare consumables to the user free of charge within a predetermined period; (c)the front-end server recording a consumed amount of the plurality of the healthcare consumables; and (d)when the consumed amount reaches a first threshold, the front-end server submitting a requisition to replenish the healthcare consumables free of charge to the back-end server via a communication network.
2. The method according to Embodiment 1, wherein the front-end server provides the purchasing program to the user through the communication network, the back-end server receives a message indicating the purchasing program chosen by the user via the communication network, and dispatches the healthcare consumables to the user.
3. The method according to the previous embodiments, wherein the front-end server sends a reminder to submit the requisition to the user prior to submitting the requisition to the back-end server, and submits the requisition after receiving a confirmation signal from the user.
4. The method according to the previous embodiments, further comprising a step of the back-end server, via the communication network, dispatching a measurement device to the user after receiving a message indicating the purchasing program chosen by the user.
5. The method according to Embodiment claim 4, wherein the front-end server includes a user identity validation program, and responds, via the communication network, to the back-end server a request to provide one of an identity of the user, an identification code of the measurement device and an icon to the measurement device.
6. The method according to Embodiment 4, wherein the measurement device stores a predetermined consumption amount, which is variable based on the consumed amount of the healthcare consumables.
7. The method according to Embodiment 6, wherein a value of the predetermined consumption amount is set to be one of equal to and larger than the number of the plurality of the healthcare consumables.
8. The method as according to Embodiment 6, further comprising a step of when the consumed amount of the healthcare consumables exceeds the predetermined consumption amount, the back-end server, via the communication network, receiving the requisition to replenish the healthcare consumables free of charge, and dispatching the consumed amount of the healthcare consumables, while the front-end server submitting an instruction to reset the predetermined consumption amount.
9. The method according to Embodiment 6, further comprising: when the consumed amount of the healthcare consumables exceeds a second threshold, terminating a measurement function of the measurement device corresponding to the healthcare consumables.
10. The method according to Embodiment 6, further comprising: the back-end server receiving a consumption record of the healthcare consumables from the front-end server, and tracking the user's consumption status of the health consumables based on the consumption record.
11. The method according to the previous embodiments, wherein the measurement device is configured to measure at least one of a blood glucose, a uric acid, a cholesterol, a blood ketone, a pesticide, a heavy metal, a carcinogen and an environmental contaminant.
12. The method according to the previous embodiments, wherein the consumed amount is derived by calculating a total consumption amount from the measurement device, a variation of the predetermined consumption amount, a count of the data measurements of the healthcare consumables uploaded from the measurement device to the front-end server and a combination thereof.
13. A system for providing a purchasing program to obtain healthcare consumables, comprising a measurement device configured to work with the healthcare consumable, and record a consumed amount of the healthcare consumable; and a communication module submitting a requisition to replenish the healthcare consumables free of charge when the consumed amount reaches a first threshold, based on the purchasing program.
14. The according to Embodiment 13, wherein the measurement device includes a physiological measurement device having an embedded communication unit and a user equipment being capable of loading a program.
15. The according to Embodiment 13, wherein the measurement device is configured to be a user equipment having an embedded physiological measurement device and being capable of loading a program.
16. The according to Embodiments 13-15, wherein the measurement device is configured to be a physiological measurement device having an embedded communication unit.
17. A method of initiating reminders to replenish free healthcare consumables on a front-end server to a computer for implementation, including steps of: providing at least a purchasing program for a user to choose from; detecting a consumption amount of the healthcare consumables; and submitting a reminder for free replenishment of the healthcare consumables when the consumption amount of the healthcare consumables reaches a threshold.
18. The method according to Embodiment 17, wherein the purchasing program includes a back-end service providing a plurality of the healthcare consumables to the user in the first instance and providing the healthcare consumables to the user free of charge within a predetermined period.
19. The method according to Embodiment 18, wherein the purchasing program further includes that the back-end server dispatches a measurement device to the user after receiving a message indicating the purchasing program chosen by the user.
20. The method according to Embodiment claim 18, wherein the back-end server dispatches the healthcare consumables to the user after the user has confirmed the reminder for free replenishment of the healthcare consumables.

What is claimed is:

1. A method of providing healthcare consumables, comprising:
providing a front-end server and a back-end server;
the front-end server providing at least a purchasing program for a user to choose from, wherein the purchasing program includes providing a plurality of the healthcare consumables to the user in the first instance and providing the healthcare consumables to the user free of charge within a predetermined period;
the front-end server recording a consumed amount of the plurality of the healthcare consumables; and
when the consumed amount reaches a first threshold, the front-end server submitting a requisition to replenish the healthcare consumables free of charge to the back-end server via a communication network.

2. The method as claimed in claim 1, wherein the front-end server provides the purchasing program to the user through the communication network, the back-end server receives a message indicating the purchasing program chosen by the user via the communication network, and dispatches the healthcare consumables to the user.

3. The method as claimed in claim 1, wherein the front-end server sends a reminder to submit the requisition to the user prior to submitting the requisition to the back-end server, and submits the requisition after receiving a confirmation signal from the user.

4. The method as claimed in claim 1, further comprising a step of the back-end server, via the communication network, dispatching a measurement device to the user after receiving a message indicating the purchasing program chosen by the user.

5. The method as claimed in claim 4, wherein the front-end server includes a user identity validation program, and responds, via the communication network, to the back-end server a request to provide one of an identity of the user, an identification code of the measurement device and an icon to the measurement device.

6. The method as claimed in claim 4, wherein the measurement device stores a predetermined threshold, which is variable based on the consumed amount of the healthcare consumables.

7. The method as claimed in claim 6, wherein a value of the predetermined consumption amount is set to be equal to or larger than the number of the plurality of the healthcare consumables.

8. The method as claimed in claim 6, further comprising a step of:
when the consumed amount of the healthcare consumables exceeds the predetermined threshold, the back-end server, via the communication network, receiving the requisition to replenish the healthcare consumables free of charge, and dispatching the consumed amount of the healthcare consumables, while the front-end server submitting an instruction to reset the predetermined consumption amount.

9. The method as claimed in claim 6, further comprising:
when the consumed amount of the healthcare consumables exceeds a second threshold, terminating a measurement function of the measurement device corresponding to the healthcare consumables.

10. The method as claimed in claim 6, further comprising:
the back-end server receiving a consumption record of the healthcare consumables from the front-end server, and tracking the user's consumption status of the health consumables based on the consumption record.

11. The method as claimed in claim 6, wherein the measurement device is configured to measure at least one of a blood glucose, a uric acid, a cholesterol, a blood ketone, a pesticide, a heavy metal, a carcinogen and an environmental contaminant.

12. The method as claimed in claim 6, wherein the consumed amount is derived by calculating a total consumption amount from the measurement device, a variation of the predetermined consumption amount, a count of the data measurements of the healthcare consumables uploaded from the measurement device to the front-end server and a combination thereof.

13. A system for providing a purchasing program to obtain healthcare consumables, comprising:
a measurement device configured to work with the healthcare consumable, and record a consumed amount of the healthcare consumable; and
a communication module submitting a requisition to replenish the healthcare consumables free of charge when the consumed amount reaches a first threshold, based on the purchasing program.

14. The system as claimed in claim 13, wherein the measurement device includes a physiological measurement device having an embedded communication unit and a user equipment being capable of loading a program.

15. The system as claimed in claim 13, wherein the measurement device is configured to be a user equipment having an embedded physiological measurement device and being capable of loading a program.

16. The system as claimed in claim 13, wherein the measurement device is configured to be a physiological measurement device having an embedded communication unit.

17. A method of initiating reminders to replenish free healthcare consumables on a front-end server to a computer for implementation, including steps of:
providing at least a purchasing program for a user to choose;
detecting a consumption amount of the healthcare consumables; and
submitting a reminder for free replenishment of the healthcare consumables when the consumption amount of the healthcare consumables reaches a threshold.

18. The method as claimed in claim 17, wherein the purchasing program includes a back-end service providing a plurality of the healthcare consumables to the user in the first instance and providing the healthcare consumables to the user free of charge within a predetermined period.

19. The method as claimed in claim 18, wherein the purchasing program further includes that the back-end server dispatches a measurement device to the user after receiving a message indicating the purchasing program chosen by the user.

20. The method as claimed in claim 18, wherein the back-end server dispatches the healthcare consumables to the user after the user has confirmed the reminder for free replenishment of the healthcare consumables.
